(19) United States
(12) Patent Application Publication
(10) Pub. No.: US 2016/0234243 A1
(43) Pub. Date: Aug. 11, 2016

(54) TECHNIQUE FOR USING INFRASTRUCTURE MONITORING SOFTWARE TO COLLECT CYBER-SECURITY RISK DATA

(71) Applicant: Honeywell International Inc., Morris Plains, NJ (US)

(72) Inventors: Venkata Srinivasulu Reddy Talamanchi, Bangalore (IN); Eric T. Boice, Mesa, AZ (US); Ganesh P. Gadhe, Pune (IN); Kenneth W. Dietrich, Glendale, AZ (US); Andrew W. Kowalczyk, Phoenix, AZ (US)

(21) Appl. No.: 14/871,855

(22) Filed: Sep. 30, 2015

Related U.S. Application Data
(60) Provisional application No. 62/113,100, filed on Feb. 6, 2015.

(51) Int. Cl. H04L 29/06

(52) U.S. Cl. CPC H04L 63/1433; H04L 63/1416; H04L 63/02; H04L 63/20

(57) ABSTRACT

This disclosure provides a technique for using infrastructure monitoring software to collect cyber-security risk data. A method includes sending first information from a risk manager system to a plurality of agents each associated with a respective device in a computing system. The first information is associated with one or more risk-monitoring configurations. The method includes receiving second information by the risk manager system from the agents. The second information identifies identified vulnerabilities and events associated with the respective devices. The method includes storing and displaying to a user at least one of the second information and an analysis of the second information.

### CROSS-REFERENCE TO RELATED APPLICATION

This application claims the benefit of the filing date of U.S. Provisional Patent Application 62/113,100, filed Feb. 6, 2015, which is hereby incorporated by reference.

### TECHNICAL FIELD

This disclosure relates generally to network security. More specifically, this disclosure relates to a technique for using infrastructure monitoring software to collect cyber-security risk data.

### BACKGROUND

Processing facilities are often managed using industrial process control and automation systems. Conventional control and automation systems routinely include a variety of networked devices, such as servers, workstations, switches, routers, firewalls, safety systems, proprietary real-time controllers, and industrial field devices. Often times, this equipment comes from a number of different vendors. In industrial environments, cyber-security is of increasing concern, and unaddressed security vulnerabilities in any of these components could be exploited by attackers to disrupt operations or cause unsafe conditions in an industrial facility.

### SUMMARY

This disclosure provides a technique for using infrastructure monitoring software to collect cyber-security risk data, including methods and corresponding systems and machine-readable media. A method includes sending first information from a risk manager system to a plurality of agents each associated with a respective device in a computing system. The first information is associated with one or more risk-monitoring configurations. The method includes receiving second information by the risk manager system from the agents. The second information identifies identified vulnerabilities and events associated with the respective devices. The method includes storing and displaying to a user at least one of the second information and an analysis of the second information.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIG. 2 illustrates an example architecture supporting a technique for using infrastructure monitoring software to collect cyber-security risk data according to this disclosure; and

FIG. 3 illustrates a flowchart of a process in accordance with disclosed embodiments.

### DETAILED DESCRIPTION

The figures, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

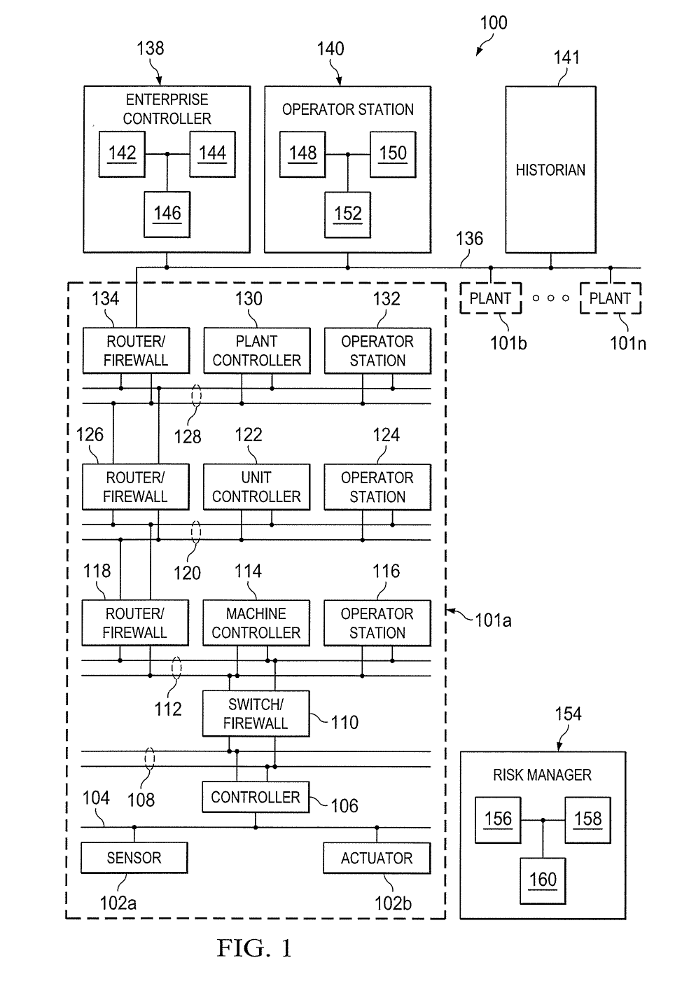

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Each controller 106 includes any suitable structure for interacting with one or more sensors 102a and controlling one or more actuators 102b. Each controller 106 could, for example, represent a proportional-integral-derivative (PID) controller or a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As a particular example, the networks 108 could represent a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers 106, 114, 122, 130, 138 could include one or more processing devices 142 and one or more memories 144 for storing instructions and data used, generated, or collected by the processing device(s) 142. Each of the controllers 106, 114, 122, 130, 138 could also include at least one network interface 146, such as one or more Ethernet interfaces or wireless transceivers. Also, each of the operator stations 116, 124, 132, 140 could include one or more processing devices 148 and one or more memories 150 for storing instructions and data used, generated, or collected by the processing device(s) 148. Each of the operator stations 116, 124, 132, 140 could also include at least one network interface 152, such as one or more Ethernet interfaces or wireless transceivers.

In the networking world, security is a primary concern, and numerous solutions are available to secure servers, workstations, switches, routers, and firewalls on a network. For example, there are various solutions supporting functions such as:
Threat, malware, and virus detection
Application whitelisting
Firewalls (hardware and software)
Network device monitoring (such as for switches and routers)
Up-to-date software patching

Solutions such as these can be used to help secure systems and devices all over the world. However, there is currently no mechanism to collect data from these various software tools in order to provide a high-level view of an entire network. Instead, administrators have to monitor these multiple software tools on different systems to secure a network. A software tool that can collect data from various systems, monitor an entire network, and provide data that indicates the health of the entire network would be very useful. This disclosure provides a risk manager 154 supporting such a software tool.

The risk manager 154 includes any suitable structure that supports a technique for using infrastructure monitoring software to collect cyber-security risk data. Here, the risk manager 154 includes one or more processing devices 156; one or more memories 158 for storing instructions and data used, generated, or collected by the processing device(s) 156; and at least one network interface 160. Each processing device 156 could represent a microprocessor, microcontroller, digital signal process, field programmable gate array, application specific integrated circuit, or discrete logic. Each memory 158 could represent a volatile or non-volatile storage and retrieval device, such as a random access memory or Flash memory. Each network interface 160 could represent an Ethernet interface, wireless transceiver, or other device facilitating external communication. The functionality of the risk manager 154 could be implemented using any suitable hardware or a combination of hardware and software/firmware instructions.

Although FIG. 1 illustrates one example of an industrial process control and automation system 100, various changes may be made to FIG. 1. For example, a control and automation system could include any number of sensors, actuators, controllers, servers, operator stations, networks, risk managers, and other components. Also, the makeup and arrangement of the system 100 in FIG. 1 is for illustration only. Components could be added, omitted, combined, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates an example environment in which the functions of the risk manager 154 can be used. This functionality can be used in any other suitable device or system.

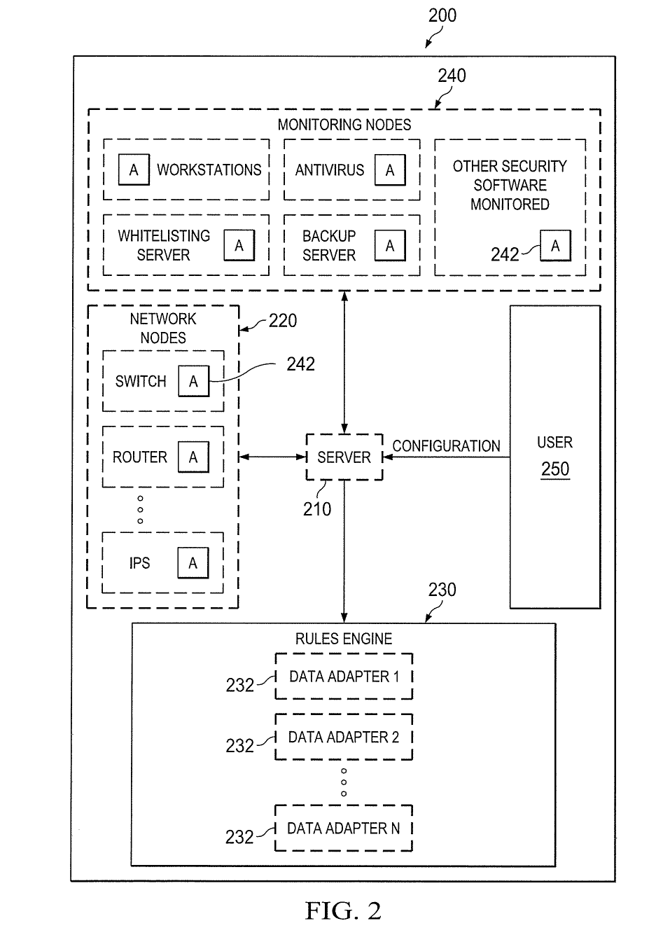

FIG. 2 illustrates an example architecture 200 supporting a technique for using infrastructure monitoring software to collect cyber-security risk data according to this disclosure. The architecture 200 could be supported or implemented using the risk manager 154. This architecture 200 supports a technique for using infrastructure monitoring software to collect cyber-security risk data.

Architecture 200 includes, in this example, a server 210, network nodes 220, a rules engine 230, monitoring nodes 240, and a user system 250. Server 210 can be implemented as risk manager 154, or as another server data processing system, having such hardware components as a processing device(s), memory, and a network interface. User system 250, similarly, can be any data processing system configured to communicate with server 210 as described herein, and in particular for configuring the processes described herein, and can be also be implemented as risk manager 154. Note that user system 250, in some embodiments, can be implemented on the same physical system as server 210.

Server 210, for example as executed by the risk manager 154, collects various data from monitoring nodes 240, such as data from antivirus tools or application whitelisting tools, Windows security events, network security data (including states of switches, routers, firewalls, and intrusion detection/prevention systems), backup status, patching status, and asset policies. Other examples are shown as monitoring nodes 240, including workstations, whitelisting servers, antivirus systems, backup servers, and other security software. Similarly, network nodes 220 can also be monitored. Network nodes 220 can include switches, routers, intrusion prevention systems (IPSes) including firewalls, and other network devices, whether implemented in hardware or software.

To start monitoring the monitoring nodes 240, a configuration can be loaded into and received by server 210, such as by receiving it from user system 250, loading it from storage, receiving it from another device or process, or otherwise. This configuration can be pushed to respective agents 242 (denoted “A” in FIG. 2, label 242 not shown for each agent) on the monitoring nodes 240 or network nodes 220 by server 210. Both the agents 242 and the server 210 know about configuration categories, and each type and subtype of data collection can have its own category identifier. Agents 242 scan devices for known vulnerabilities on each device or software application (such as out-of-date Windows patches) and monitor the devices continuously for events with security implications (such as virus detections or Windows authentication failures). Areas of monitoring may include, but are not limited to, antivirus, application whitelisting, Windows security events, network security (including state of switches, routers, firewalls, and intrusion detection/prevention systems), backup status, patching status and asset policies. Each agent 242 translates events generated on its device into alerts and assigns its configuration identifier.

Server 210 can collect or receive this information from each agent 242, analyze the information, and present the information and the analysis results to an operator (such as an administrator), store the information and results, or transmit them to a user system 250.

In various embodiments, rules engine 230 uses data adapters 232 to translate data to and from each of the agents 242, as necessary, so that the appropriate data can be sent to each agent 242, and so that the data received from each agent 242 can be converted into a consistent format for use by server 210. By converting data into a consistent format, rules engine 154 can present a “dashboard” user interface by which the relative risks from each of the monitored nodes can be easily compared.

Disclosed embodiments can be implemented, in some embodiments, on top of infrastructure monitoring tools such as the System Center Operations Manager (SCOM) infrastructure monitoring software tool from MICROSOFT CORPORATION. Disclosed embodiments can provide an infrastructure for collecting risk data from agents and for pushing custom configurations in the form of management packs. The data collected by SCOM, as modified or used as disclosed herein, can be stored in an SCOM database called the Operations Manager database. The data in the Operations Manager database can be read using SQL or the MOM (Microsoft Operations Manager) Application Program Interface (API).

Although FIG. 2 illustrates one example of an architecture 200 supporting a technique for using infrastructure monitoring software to collect cyber-security risk data, various changes may be made to FIG. 2. For example, the functional division of the components and sub-component in FIG. 2 are for illustration only. Various components or sub-components could be combined, further subdivided, rearranged, or omitted and additional components or sub-components could be added according to particular needs.

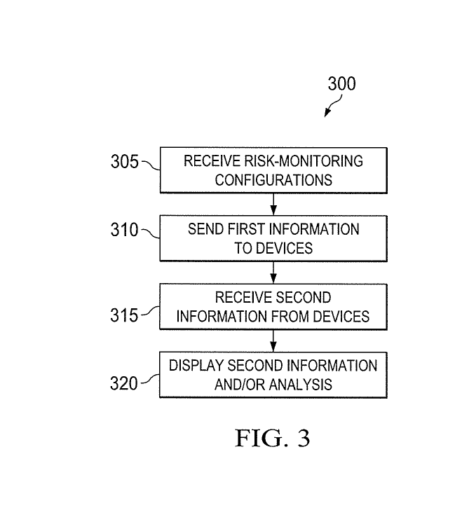

FIG. 3 illustrates a flowchart of a process 300 in accordance with disclosed embodiments, that can be performed, for example, by risk manager 154, architecture 200, or other device configured to perform as described, referred to generically as the “risk manager system” below.

The risk manager system receives one or more risk-monitoring configurations (305).

The risk manager system sends first information to agents associated with multiple devices in a computing system, where the first information is associated with one or more of the risk-monitoring configurations (310). As part of this process, the risk manager system can translate the one or more risk-monitoring configurations into the first information according to the requirements of the respective devices.

The risk manager system receives second information from the respective agents (315), where the second information identifies identified vulnerabilities and events associated with the devices. As a part of this process, the system can translate the second information into a consistent format from the formats of the respective devices.

The risk manager system stores and displays at least one of the second information and an analysis of the second information to a user (320).

Note that the risk manager 154 and/or the architecture 200 shown here could use or operate in conjunction with any combination or all of various features described in the following previously-filed and concurrently-filed patent applications (all of which are hereby incorporated by reference):
U.S. patent application Ser. No. 14/482,888 entitled “DYNAMIC QUANTIFICATION OF CYBER-SECURITY RISKS IN A CONTROL SYSTEM”;
U.S. Provisional Patent Application No. 62/036,920 entitled “ANALYZING CYBER-SECURITY RISKS IN AN INDUSTRIAL CONTROL ENVIRONMENT”;
U.S. Provisional Patent Application No. 62/113,075 entitled “RULES ENGINE FOR CONVERTING SYSTEM-RELATED CHARACTERISTICS AND EVENTS INTO CYBER-SECURITY RISK ASSESSMENT VALUES” and corresponding non-provisional U.S. patent application Ser. No. ______ of like title (Docket No. H0048932-0115) filed concurrently herewith;
U.S. Provisional Patent Application No. 62/113,221 entitled “NOTIFICATION SUBSYSTEM FOR GENERATING CONSOLIDATED, FILTERED, AND RELEVANT SECURITY RISK-BASED NOTIFICATIONS” and corresponding non-provisional U.S. patent application Ser. No. ______ of like title (Docket No. H0048937-0115) filed concurrently herewith;
U.S. Provisional Patent Application No. 62/113,186 entitled “INFRASTRUCTURE MONITORING TOOL FOR COLLECTING INDUSTRIAL PROCESS CONTROL AND AUTOMATION SYSTEM RISK DATA” and corresponding non-provisional U.S. patent application Ser. No. ______ of like title (Docket No. H0048945-0115) filed concurrently herewith;
U.S. Provisional Patent Application No. 62/113,165 entitled “PATCH MONITORING AND ANALYSIS” and corresponding non-provisional U.S. patent application Ser. No. ______ of like title (Docket No. H0048973-0115) filed concurrently herewith;
U.S. Provisional Patent Application No. 62/113,152 entitled “APPARATUS AND METHOD FOR AUTOMATIC HANDLING OF CYBER-SECURITY RISK EVENTS” and corresponding non-provisional U.S. patent application Ser. No. ______ of like title (Docket No. H0049067-0115) filed concurrently herewith;
U.S. Provisional Patent Application No. 62/114,928 entitled “APPARATUS AND METHOD FOR DYNAMIC CUSTOMIZATION OF CYBER-SECURITY RISK ITEM RULES” and corresponding non-provisional U.S. patent application Ser. No. ______ of like title (Docket No. H0049099-0115) filed concurrently herewith;
U.S. Provisional Patent Application No. 62/114,865 entitled “APPARATUS AND METHOD FOR PROVIDING POSSIBLE CAUSES, RECOMMENDED ACTIONS, AND POTENTIAL IMPACTS RELATED TO IDENTIFIED CYBER-SECURITY RISK ITEMS” and corresponding non-provisional U.S. patent application Ser. No. ______ of like title (Docket No. H0049103-0115) filed concurrently herewith;
U.S. Provisional Patent Application No. 62/114,937 entitled “APPARATUS AND METHOD FOR TYING CYBER-SECURITY RISK ANALYSIS TO COMMON RISK METHODOLOGIES AND RISK LEVELS” and corresponding non-provisional U.S. patent application Ser. No. ______ of like title (Docket No. H0049104-0115) filed concurrently herewith; and
U.S. Provisional Patent Application No. 62/116,245 entitled “RISK MANAGEMENT IN AN AIR-GAPPED ENVIRONMENT” and corresponding non-provisional U.S. patent application Ser. No. ______ of like title (Docket No. H0049081-0115) filed concurrently herewith.
   In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
sending first information from a risk manager system to a plurality of agents each associated with a respective device in a computing system, the first information associated with one or more risk-monitoring configurations;
receiving second information by the risk manager system from the agents, the second information identifying vulnerabilities and events associated with the respective devices; and
storing and displaying to a user at least one of the second information and an analysis of the second information.

2. The method of claim 1, further comprising receiving the risk-monitoring configurations.

3. The method of claim 1, further comprising translating the one or more risk-monitoring configurations into the first information according to requirements of the respective devices.

4. The method of claim 1, further comprising translating the second information into a consistent format from a plurality of formats associated with the respective devices.

5. The method of claim 1, wherein the devices are network nodes, including switches, routers, and intrusion prevention systems.

6. The method of claim 1, wherein the devices are monitoring nodes, including one or more of workstations, whitelisting servers, antivirus systems, backup servers, and other security software.

7. The method of claim 1, wherein the risk manager system includes a rules engine that uses data adapters to translate data to and from each of the agents.

8. A risk manager system comprising:
a controller; and
a display, the risk manager system configured to
send first information to a plurality of agents each associated with a respective device in a computing system, the first information associated with one or more risk-monitoring configurations;
receive second information from the agents, the second information identifying vulnerabilities and events associated with the respective devices; and
store and display to a user at least one of the second information and an analysis of the second information.

9. The risk manager system of claim 8, wherein the risk manager system also receives the risk-monitoring configurations.

10. The risk manager system of claim 8, wherein the risk manager system translates the one or more risk-monitoring configurations into the first information according to requirements of the respective devices.

11. The risk manager system of claim 8, wherein the risk manager system translates the second information into a consistent format from a plurality of formats associated with the respective devices.

12. The risk manager system of claim 8, wherein the devices are network nodes, including switches, routers, and intrusion prevention systems.

13. The risk manager system of claim 8, wherein the devices are monitoring nodes, including one or more of workstations, whitelisting servers, antivirus systems, backup servers, and other security software.

14. The risk manager system of claim 8, wherein the risk manager system includes a rules engine that uses data adapters to translate data to and from each of the agents.

15. A non-transitory machine-readable medium encoded with executable instructions that, when executed, cause one or more processors of a risk manager system to:
send first information to a plurality of agents each associated with a respective device in a computing system, the first information associated with one or more risk-monitoring configurations;
receive second information from the agents, the second information identifying vulnerabilities and events associated with the respective devices; and
store and display to a user at least one of the second information and an analysis of the second information.

16. The non-transitory machine-readable medium of claim 15, wherein the risk manager system also receives the risk-monitoring configurations.

17. The non-transitory machine-readable medium of claim 15, wherein the risk manager system translates the one or more risk-monitoring configurations into the first information according to requirements of the respective devices.

18. The non-transitory machine-readable medium of claim 15, wherein the risk manager system translates the second information into a consistent format from a plurality of formats associated with the respective devices.

19. The non-transitory machine-readable medium of claim 15, wherein the devices are network nodes, including switches, routers, and intrusion prevention systems.

20. The non-transitory machine-readable medium of claim 15, wherein the devices are monitoring nodes, including one or more of workstations, whitelisting servers, antivirus systems, backup servers, and other security software.
